(19) United States
(12) Patent Application Publication
(10) Pub. No.: US 2025/0235835 A1
(43) Pub. Date: Jul. 24, 2025

(54) STIRRER WITH DETACHABLE PARTS

(71) Applicant: Xiongwei Cai, Arlington, MA (US)

(72) Inventor: Xiongwei Cai, Arlington, MA (US)

(21) Appl. No.: 18/421,891

(22) Filed: Jan. 24, 2024

(51) Int. Cl. B01F 27/27; B01F 27/07; B01F 27/111; B01F 27/211; B01F 27/2122; B01F 35/90; B01F 35/95

(52) U.S. Cl. CPC B01F 27/27; B01F 27/071; B01F 27/111; B01F 27/211; B01F 27/2122; B01F 35/95; B01F 2035/98

(57) ABSTRACT

This application discloses a stirrer with a direct drive motor comprising a stator module with a rod mounted onto a stator and a rotor module comprising a rotor encapsulated in a housing and connected to an impeller. In some embodiments the rod functions as a cooling device to prevent the stator from being overheated during stirring. The stator module and the rotor are encapsulated in their separate housing and are detachable from each other and the impeller to allow the user to clean, disinfect, maintain or repair the stator module, rotor, impeller, and coupling between the stator module and the rotor before further use. Depending on the type of impeller added, it may be used for moving, stirring, mixing, agitating, blending, aerating, homogenizing, or cutting the medium.

### CROSS-REFERENCE TO RELATED APPLICATION

This Patent application claims priority to U.S. Provisional Patent Application No. 63/481,589, filed on Jan. 25, 2023, and entitled “STIRRER WITH DETACHABLE PARTS.” The disclosure of the prior Application is considered part of and is incorporated by reference into this Patent Application.

### BACKGROUND

The present invention relates to overhead stirrers, particularly overhead stirrers with a direct drive suitable for stirring and mixing required in common chemical, biochemical or biological procedures, and food processing.

Typically, to protect the sensitive electronic parts of the drive, i.e., the stator and the rotor, an overhead stirrer is equipped with a long rigid shaft to transfer the torque from the drive to the impeller submerged in the medium. Stirring and mixing processes often require an isolated environment. In many settings, traditional sealing methods do not perform well, especially when high pressure or low pressure is required.

In current sealing techniques, lubricants are applied on the shaft's surface to seal the shaft and they are prone to leak and contaminate the medium, especially when the mixing process requires positive-or negative-pressure or high-temperature conditions. Lubrication also needs regular maintenance, and lubricants make cleaning, sterilizing, and repairing the equipment more challenging.

Another solution is to use a two-piece shaft, with one stationary and one moving part encased in separate corrosion-resistant housings, to connect the drive to the impeller. The housing has permanent magnets integrated to couple the two pieces together. Drives with magnetic coupling are widely used in various industries to secure moving parts effectively. For example, Buchi AG, a Switzerland corporation, offers the cyclone and bmd series stirrer drives with such permanent magnet coupling.

While magnetic coupling assemblies decrease the likelihood of lubricant leaks, they are also potential sources of contamination because they still need lubricants and moving bears between the moving and stationary parts, and the permanent magnets integrated into the housing attract electrostatic and magnetic particles. In addition, during the agitation, the cavity in the housing of the permanent magnetic coupling tends to collect contaminants from the agitated medium. Another issue with magnetically coupled drives is that, depending on the shaft's length and rotational speed, they may make the stirrer prone to wobbling; thus, drives with magnetic coupling may require an additional support structure to compensate for the instability.

Therefore, there is a need for a drive with detachable parts that can operate for a long time without instability, do not require complicated sealing solutions, and can easily be cleaned and maintained.

### SUMMARY

In one general aspect, apparatus may include a stator module disposed within a single housing and having: an annular-shaped stator having a substantially co-axially disposed stator aperture, the stator having electrical windings, and a stationary rod having a first end and a second end, the second end extends through said stator aperture, where the stator module housing prevents the medium from contacting the stator and windings when the apparatus is at least partially submerged in the medium. Apparatus may also include a rotor disposed within a single rotor housing and rotatably coupled to the second end of the rod through removable coupling means, said rotor having: a plurality of permanent magnets mounted in an annular array on a rotor body, said magnets and said rotor body connected to the housing, where the rotor housing prevents the medium from contacting the rotor when the apparatus is at least partially submerged in the medium and where the rotor is located adjacent to and substantially co-axial with the stator and the plurality of magnets of the rotor are arranged with magnet axes substantially perpendicular to that of the axis of the apparatus and facing the electrical windings of the stator to thereby rotate about the windings when driven by the electromagnetic forces provided by the stator and windings. Apparatus may furthermore include an impeller removably coupled to the rotor and configured to be rotated about the axis of the apparatus. Other embodiments of this aspect include corresponding computer systems, apparatus, and computer programs recorded on one or more computer storage devices, each configured to perform the actions of the methods.

Implementations may include one or more of the following features. Apparatus where said stationary rod is made out of thermally conductive material. Apparatus where the rod further comprises an enclosed cavity containing a liquid capable of evaporating upon absorbing heat from the stator and traveling in its vapor phase to the first end of the rod to condense and release heat and then traveling to the second end of the rod while in liquid phase, thereby cooling the rod and the stator. Apparatus further comprising a heat sink coupled to the first end of the rod configured to facilitate the condensing of the liquid inside the rod by transferring the heat away from the second end of the rod through thermal conductivity. Apparatus further comprising one or more temperature probes capable of sensing the temperature of the stator; and a controller configured to receive the temperature information from the temperature probes of the stator and, in response thereto, to vary the rotor rotational speed by powering on and off the current the windings receive to maintain a temperature of the stator. Apparatus further comprising: one or more temperature probes placed in the medium to sense the temperature of the medium; where the controller is configured to receive a desired temperature value for the medium from an user; and where the controller is configured to receive temperature information from the one or more probes placed in the medium and the temperature probes of the stator and vary the rotor rotation speed by powering on and off the current the windings receive that energizes the stator windings to maintain a rotor rotation speed to maintain a temperature of the medium or a rate of cooling of the medium. Apparatus further comprising a fan energized by direct current through the controller, the fan configured to facilitate the condensation of the liquid inside the rod by transferring the heat away from the second end of the rod through thermal conductivity where the controller configured to receive a desired temperature value for the medium as input by an user, temperature information from one or more probes placed in the medium to sense the temperature of the medium, and the temperature sensors of the stator module, where the controller is configured to vary the speed of the fan by varying the current the fan receives and vary the rotor rotational speed by powering on and off the current the windings receive to maintain a temperature of the stator, and where the controller is configured to energize the stator windings and operate the fan simultaneously to maintain the temperature and/or the rate of cooling of the medium. Apparatus further comprising a fan configured to facilitate the condensation of the liquid inside the rod by transferring the heat away from the second end of the rod through thermal conductivity. Apparatus further comprising: a vapor-compression refrigeration system powered by a direct current source and having an evaporator through which a refrigerant flows and a compressor capable of varying the rate of flow of the refrigerant through the evaporator; where the stationary rod may include a cavity connected to the evaporator and configured to receive the refrigerant from the evaporator to cool the stator module through thermal conduction. Apparatus further comprising: one or more temperature sensors capable of sensing the temperature of the stator module; and a controller configured to receive temperature information from one or more probes placed in the medium to sense the temperature of the medium and the temperature sensors of the stator module, said controller is configured to vary the speed of the compressor by varying the current the compressor receives; where an user is capable of inputting a temperature value for the medium in the controller; and where the controller is configured to energize the stator windings and operate the vapor-compression refrigeration system simultaneously to maintain the temperature and/or the rate of cooling of the medium. Implementations of the described techniques may include hardware, a method or process, or a computer tangible medium.

In one general aspect, a method for stirring a medium may include connecting an impeller to a rotor disposed within a single rotor housing via a threaded connection, where the impeller may include a plurality of blades equally spaced from each other and attached to a ring-shaped mounting member having threads, and the rotor may include an annular array of magnets with magnetic poles connected to a rotor body and the rotor housing, such motor housing having threads configured to couple the rotor to the ring-shaped mounting member of the impeller so that the impeller is rotatable about the axis. Method for stirring a medium may also include removably connecting a stator module encapsulated in a single stator module housing to the rotor through one or more screws or bolts, where the stator module may include an annular-shaped stator having a substantially co-axially disposed stator aperture, said stator having electrical windings, and a stationary rod having a first end fixedly mounted and extending through the stator aperture where the rotor is located adjacent to and substantially co-axial with the stator and the plurality of rotor magnets are arranged with magnet axes substantially perpendicular to that of the axis of the apparatus and facing the electrical windings of the stator module to thereby rotate about the windings when driven by the electromagnetic forces provided by the stator and windings. Method for stirring a medium may furthermore include connecting a heat sink to the second end of the rod via the heat sink threads. Method may moreover include partially immerging the apparatus in the medium to be stirred. Method may also include powering up the controller to power up the windings to create electromagnetic forces to rotate the rotor about the axis of the apparatus.

In one general aspect, a method for stirring a medium may include connecting an impeller to a rotor disposed within a single rotor housing via a threaded connection, where the impeller may include a plurality of blades equally spaced from each other and attached to a ring-shaped mounting member having threads, and the rotor may include an annular array of magnets with magnetic poles connected to a rotor body and the rotor housing, such motor housing having threads configured to couple the rotor to the ring-shaped mounting member of the impeller so that the impeller is rotatable about the axis. Method for stirring a medium may also include removably connecting a stator module encapsulated in a single stator module housing to the rotor through one or more screws or bolts, where the stator module may include an annular-shaped stator having a substantially co-axially disposed stator aperture, said stator having electrical windings, and a stationary rod made out of a thermally conductive material, said rod having a first end fixedly mounted and extending through the stator aperture and a second end having threads capable of receiving a heat sink via its heat sink threads where the rotor is located adjacent to and substantially co-axial with the stator and the plurality of rotor magnets are arranged with magnet axes substantially perpendicular to that of the axis of the apparatus and facing the electrical windings of the stator module to thereby rotate about the windings when driven by the electromagnetic forces provided by the stator and windings. Method for stirring a medium may furthermore include connecting a heat sink to the second end of the rod via the heat sink threads. Method for stirring a medium may in addition include connecting the stator module to a controller configured to energize the stator windings. Method may moreover include partially immerging the apparatus in the medium to be stirred. Method may also include powering up the controller to power up the windings to create electromagnetic forces to rotate the rotor about the axis of the apparatus.

Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1, in a cut-away longitudinal view, illustrates one preferred embodiment of the apparatus submerged in a container;

FIG. 2A, in a perspective view, illustrates a stirrer in accordance with a preferred embodiment of the present invention;

FIG. 2B, in a perspective view, illustrates the inner structure of the upper portion of the stirrer in accordance with a preferred embodiment of the present invention;

FIG. 3, in a longitudinal side cross-section view, illustrates a stirrer shown in FIGS. 2A and B;

FIG. 4A is a side cross-sectional view showing a stator of a stirrer according to an embodiment of the present invention;

FIG. 4B is a top perspective view showing a stator of a stirrer, with the inner structure, according to an embodiment of the present invention;

FIG. 5A is a side view schematic illustration of the rotor in an embodiment of the present invention;

FIG. 5B, in a side cross-sectional view, illustrates the rotor of an embodiment of the present invention;

FIG. 5C, in a top view, shows the rotor with the inner structure, according to an embodiment of the present invention.

### DETAILED DESCRIPTION

Disclosed herein is a compact stirrer that mixes, stirs, agitates, or blends liquids, solids, gases, or mixtures thereof. The stirrer has a stator and rotor that can operate without applying lubricant between the stator and the rotor. It has only a few individually encapsulated and detachable parts that are connected without creating cavities that need to be sealed off or without the need to use magnetic coupling between the stator and the rotor. The parts are interchangeable and easy to clean and maintain.

The stirrer utilizes either a submersible axial flux motor or a submersible radial flux motor powered by an electric source. Embodiments of the present invention disclosed in this application may be used in laboratory applications, bioreactors, chemical and food-processing plants, and for any other application where such a device is suitable to use.

Various embodiments of the present invention are described in detail with reference to the related drawings. One should understand the disclosed systems and methods may be implemented using any number of techniques, whether or not currently known. The disclosure should in no way be limited to the illustrative implementations, drawings, and techniques illustrated below, but it may be modified within the scope of the appended claims, along with their full scope of equivalents. For example, one may modify the engine design disclosed in this application to use for other purposes, such as for pumping liquid in a harsh environment or, when integrated with a suitable propeller, to propel a watercraft or an underwater vehicle.

Directional terms such as right, left, upper, lower, upward and the like are to be understood with respect to a drawing or drawings on which a corresponding part or portion is shown.

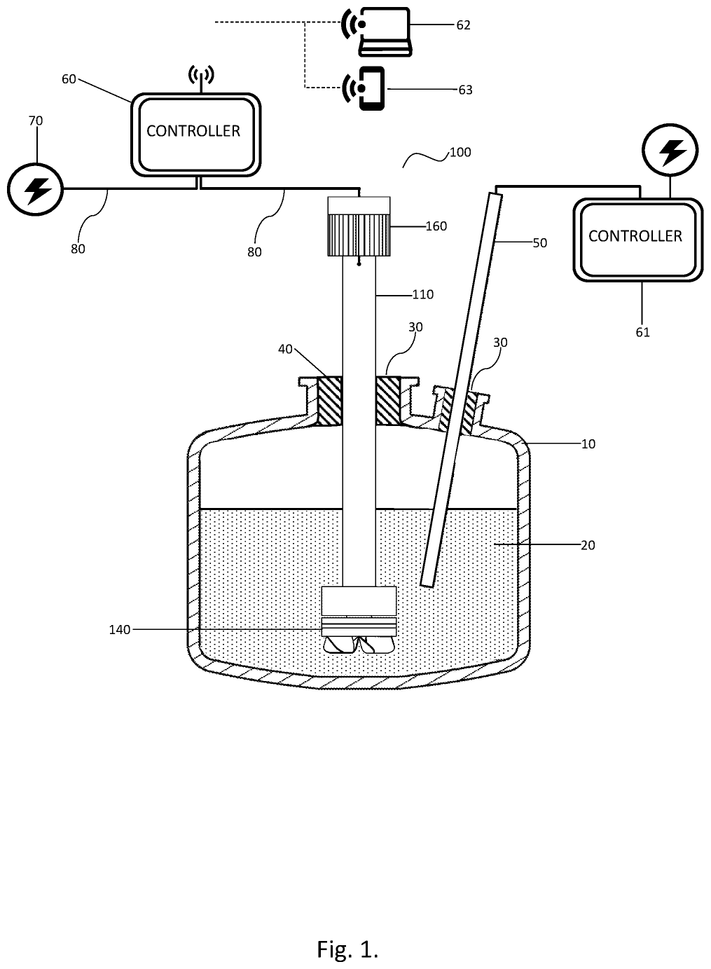

FIG. 1 illustrates one embodiment of the stirrer 100 submerged into a medium 20 in container 10. The stirrer 100 uses a controller 60 with an electric power source 70 to energize the stator windings that rotate the rotor integrated with a suitable impeller to move, stir, agitate, mix, blend, aerate, cut, kneed, homogenize, or otherwise process the medium. The container 10 may have one or more openings 30 to accommodate the stirrer 100 and, optionally, one or more probes 50 to measure the physical and chemical properties of the medium to monitor and control the stirrer during operation. The probes may measure the medium's temperature, pH, viscosity, osmolality, conductivity, or other properties. The container may have additional openings to add matter to the medium or insert one or more baffles. Optionally, some of the openings 30 may be fitted with sealing 40, for example, a ring sealing shown in FIG. 1.

The controller 60 may be connected to a display device, another output device, or another controller 61 that communicates data received from the probes, such data indicative of conditions inside the container or the stirrer's operation. Controller 60 may also receive data from an optional rotation sensor (such a sensor may be an optical, Hall-Effect, or any other suitable type of sensor) measuring the rotor module's placement. Each controller comprises at least one processor and associated circuitry and a user interface to input conditions, such as the desired temperature for the medium. Controllers 60 and 61 are programmed using techniques familiar to persons skilled in the art, such as the P.I.D. algorithm, to monitor and control the stirring speed and to cool or maintain a desired temperature of the medium in response to the output signals received from the temperature probes. The display device, another output device, or controller may be a computer 62 or a telephone 63 programmed to input, receive, or display operational data related to stirring or otherwise processing the medium. Controllers 60 and 61 may communicate with one another or with computers 62 and 63 through wired, wireless, or other communications media.

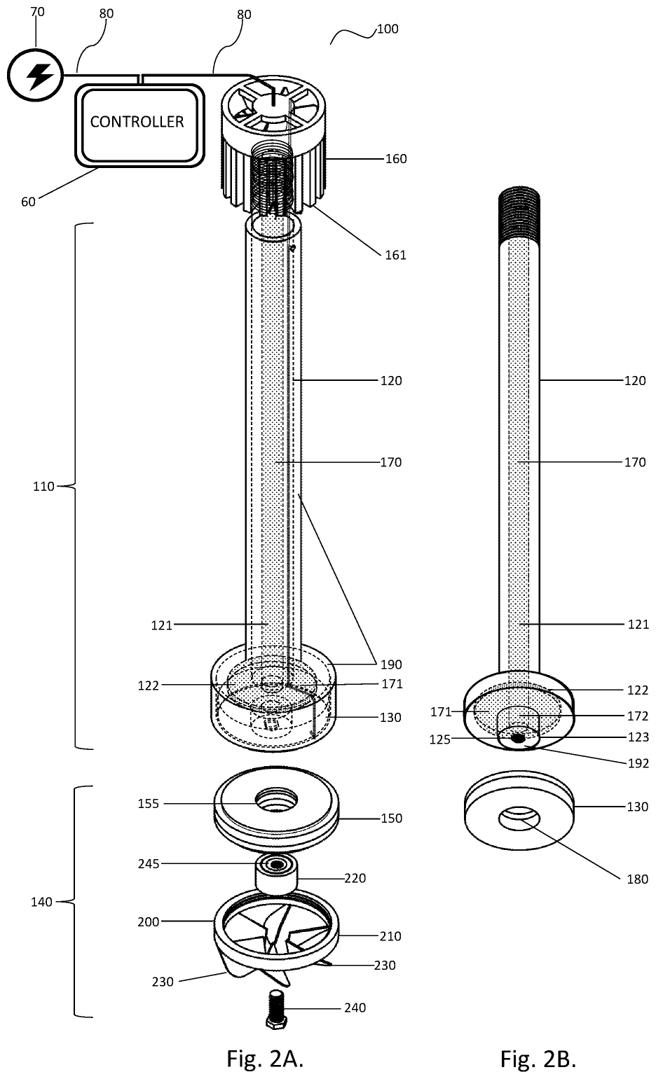

FIGS. 2A and B illustrate an example of the stirrer utilizing an axial flux motor. The stirrer 100 comprises a stator module 110 with a substantially co-axial upper portion (also referred to here as “rod”) 120 connected to a substantially co-axial stator 130, and, facing the stator module 110, a substantially co-axial rotor module 140 comprising a rotor and blades.

The rotor module 140 is removably coupled to the stator module 110 via a fastener 240 in a manner that permits the rotor to rotate about the stirrer's longitudinal axis 440. One or more screws, studs, nuts, bolts, and any combinations thereof may be used to fasten the stator module to the rotor module, along with any other suitable removable coupling technique or method.

The rod 120 may comprise an upper portion 121 positioned above the stator 130 and a lower portion 123 received within and extending through the central circular aperture 180 of the stator 130. The lower portion 123 may even extend beyond the stator and, together with the removable fastener 240, defining an axially planar gap 300 between the stator module 110 and the rotor module 140.

In some embodiments, the outer diameter of the rod 120 is not uniform along its length. For example, in the exemplary embodiment depicted in FIG. 2, the upper portion 121 of the rod may have a smaller diameter at the top that, co-axially with the stator 130, expands into a larger diameter portion 122 just above the stator 130, having the same or greater outer diameter than that of the stator 130.

In some embodiments, the stirrer does not need cooling because the medium can keep the stator's temperature within the optimal operational range. If the stirrer needs additional cooling to protect the stator or the medium from overheating, the rod 120 may be constructed out of any thermally conductive material, such as metals, alloys, plastics, ceramics, inorganic materials, and their mixtures and compositions thereof. If further cooling is needed, the rod 120 may be connected to a heatsink 160.

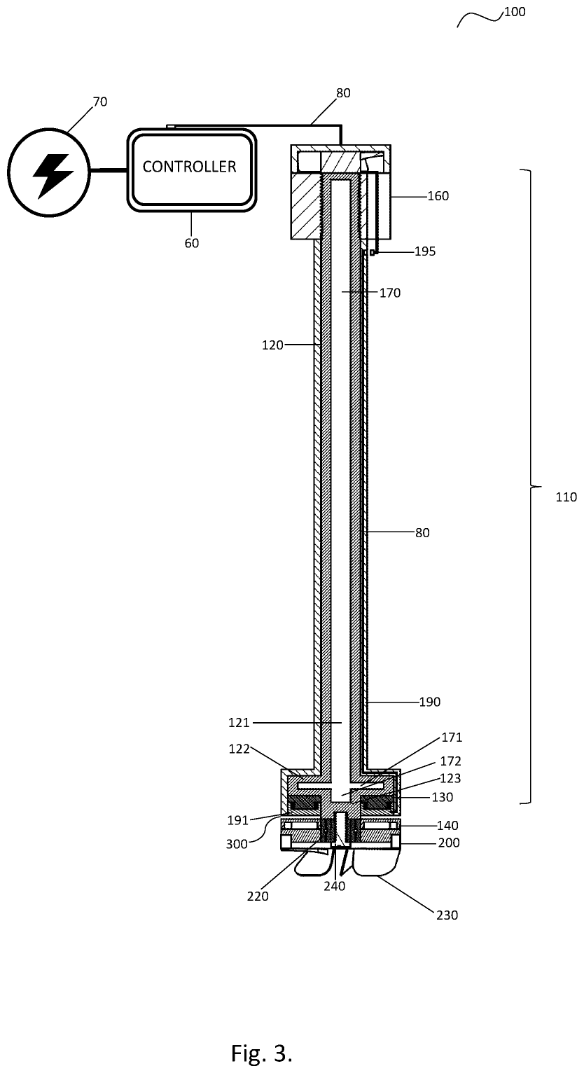

The rod 120 may have a solid core, preferably made out of metal or an alloy, or other suitable materials. If the rod 120 has a solid core, the core and the outer surface may be constructed out of the same or different materials. In other embodiments, the rod 120 may be hollow, and a single continuous cavity 170 is defined within the rod that may serve as a reservoir for a coolant. The cavity 170 may comprise multiple compartments with variable diameters: For example, in exemplary embodiments depicted in FIGS. 2 and 3, the cavity has three compartments with different diameters, 170, 171, and 172. In preferred embodiments, the pressure inside the stator unit may be lower, equal, or higher than the atmospheric pressure, and the boiling point of the coolant overlaps or is close to the desired temperature of the medium. A non-inclusive list of suitable coolants may include water, solutions or mixtures of water with salts, ammonia, aqueous ammonia solutions, acetone, methanol, ethanol, isopropanol, other kinds of alcohol, other kinds of solvents, and solutions and mixtures thereof. The term “solvents” includes, but is not limited to, alcohols, esters, ketones, ethers, hydrocarbons, halogenated hydrocarbons, and any mixtures thereof. The list of coolants may also include commercially available refrigerants used in evaporation-compressor systems and their mixtures with other coolants.

In some embodiments, the rod 120 is coupled to a heat sink 160 to transfer the heat away from the stator 130. The heat sink 160 may be mounted onto the rod 120 via a threaded connector or other suitable types of coupling means to allow for placing a ring-shaped seal 40 around the stator module. The heat sink 160 may have one or more fins 161 to dissipate the heat from the rod. In these embodiments, in response to the temperature values the controller receives from the stator, the controller may control the rotor rotational speed by setting the motor's supply voltage, or the controller may include an AC motor speed controller. Electric motors are broadly divided into the following three types: DC motors, AC motors or stepper motors. While DC motors are preferably utilized in this invention, the drive may comprise any combination of drives and control devices. Such control devices include but are not limited to speed sensor, speed detection circuit, speed reference, drive circuit and/or other hardware or software that are used for operation and control. The application does not list or draw the control or drive that is known as necessary parts for a motor.

Other embodiments may comprise a fan, a vapor compression-evaporation system, a cooling pump, or a combination thereof instead of a heat sink. A second controller 61 may also be connected to one or more temperature probes placed inside the container. Such a controller may set the optimal operating temperatures for the stirrer by adjusting the fan's rotational speed, controlling the valve in the compression-evaporation system and/or the speed of the compressor, or arranging the pump speed. The fan or the compression-evaporation system may be powered by direct current. A temperature probe positioned within the stator module 110 may be used to signal the stator temperature to controller 60. Stirrers with a vapor compression-evaporation system, pump, or fan may also be able to chill the medium, not just the stator, and the controller is capable of modulating the rotor rotational speed simultaneously with the vapor compression-evaporation system, pump, or fan. The stator module may comprise one or more rotary and/or torque sensors that communicate with the controller about the rotor module operation.

The rotor module 140 comprises a rotor 150, a blade assembly 200 mounted on the rotor, and a bearing 220 provided in the central aperture 155 of the rotor 150. In preferred embodiments, the blade assembly 200 comprises a ring-shaped mounting member 210 with threads 220 configured to be removably coupled to the rotor 150 via rotor threads 230.

In preferred embodiments, the end of the rod includes one or more holes 125 aligned with the bearing aperture 245 to receive a screw, a stud, bolt, nuts, or other suitable types of removable coupling means to couple the stator module and the rotor module. For example, the exemplary embodiment in FIG. 2. has a threaded hole for a screw or bolt received through the bearing aperture. The screw, stud, bolt, nut, or another coupling means 240 may be constructed out of a material inert to the medium, such as metals, alloys, technical ceramics, plastics, and their compounds, mixtures, or combinations thereof. Such metals and alloys may include, but not limited to, stainless steel, aluminum, nickel, nickel alloys (such as Inconel, a registered trademark of Special Metals Corporation), zinc, titanium, tin, lead, Hastelloy (a registered trademark of the Haynes International Corporation), brass and bronze. In addition, screws, bolts, studs, nuts, or other coupling means may be coated, painted on, sprayed, plated, or electro-plated with a corrosion-resistant material.

The bearing 220 can be many different types of bearings; a non-inclusive list of suitable bearings comprises ball bearings, journal bearings (e.g., a tilt-pad journal bearing), magnetic bearings, magnetic thrust bearings, hybrid magnetic bearings, and/or other types of bearings. The bearing 220 may be constructed from a corrosion-resistant material and/or coated, painted on, sprayed, plated, or electro-plated with a corrosion-resistant insulating material. Examples of suitable corrosion-resistant materials may include stainless steel, platinum, nickel alloys (such as Inconel), plastics (such as polytetrafluoroethylene and polyetheretherketone), or Hastelloy. An insulating material may be selected from a group consisting of ethylene propylene diene methylene, ethylene propylene rubber, polychloroprene, polyimide, fluoroelastomers, polypropylene, polyethylene, polyether, and copolymers, mixtures, blends, and alloys thereof. If a polyether insulating material is selected, then preferred materials are selected from the group consisting of polyetherketone, polyetheretherketone, polyetherketoneketone, polyetherketoneetherketoneketone, and mixtures, blends, and alloys thereof.

The rotor module 140 may include one or more blades 230 attached to the ring-shaped mounting member 210 of the blade assembly 200. In some embodiments, the rotor module 140 may comprise several blades 230 equally spaced in relation to each other along the circumference of the mounting member 210. The size and shape of the blades attached to the mounting member 210 may vary. In some embodiments, the blades 230 may extend beyond the outer diameter of the mounting member 210.

According to this invention and as depicted in FIG. 3, the stator module 110 is encapsulated in a single housing that comprises a top portion 190 having a circular upper wall portion surrounding the upper and lower portions of the rod, 121 and 122 and the top and side portions of the stator 130, and an annular-shaped bottom wall portion 191 that supports the stator core 420 located on the bottom of the stator module 110. In addition, the housing may also encase any portion 192 of the rod extending through the stator aperture.

The transmission cables 80 connecting the stator windings 400 to controller 60 are disposed within the top portion of housing 190. The top portion 190, lower portion 191, and the bottom wall portion 192 of the housing may be constructed out of the same or different materials. However, the lower wall portion 191 and the circular bottom wall portion 192 of the housing must be made out of non-magnetic material. Such non-magnetic material may be selected from the following non-inclusive group of materials consisting of inorganic materials, ceramics, plastics, metals, alloys, such as stainless steel, aluminum, copper, nickel, brass, bronze, platinum, nickel alloys, resins (such as epoxy resin), plastics (such as polytetrafluoroethylene and polyetheretherketone (PEEK)), Hastelloy, and any compounds, mixtures, blends or combinations thereof. In addition, housing parts 190,191, 192 may be plated, painted, sprayed, or electro-plated onto the rod and stator, or the housing may be further coated, painted, sprayed, plated, or electro-plated with any material that resists corrosion. For example, such material may be selected from the following non-inclusive group of materials consisting of Inconel, resins (such as epoxy resins), polyethers (such as polyetherketone, polyetheretherketone, polyetherketoneketon, polyetherketoneetherketoneketone), fluoropolymers (such as ethylene chlorotrifluoroethylene and/or other materials), technical ceramics, ethylene propylene diene methylene, ethylene propylene rubber, polychloroprene, polyimide, fluoroelastomers, polypropylene, polyethylene, and copolymers, mixtures, blends and alloys thereof. For example, the housing may be made out of epoxy resin, and then, the housing further coated by applying fluoropolymer over the polished epoxy resin surface.

As illustrated in FIG. 3, there is an axially planar gap 300 between the stator module 110 and rotor module 140 sized to allow the magnetic field to pass through. The width of the gap is determined by the lengths of the rod portion extending through the stator aperture and removable fastener coupling the stator module and the rotor module. In some embodiments, the gap may contain lubricant, while in other embodiments, no lubrication is necessary, as the liquid medium may be sufficient for lubrication. A sieve, not illustrated in the figures, may surround the gap 300 preventing unwanted particles in the medium from entering the gap. The sieve may reject the particles based on their size, shape, or electrostatic charge or utilize any other suitable method or combination of methods thereof. The stator module housing and rotor housing inside the gap may be coated or treated to repulse some electrostatically charged particles entering the gap.

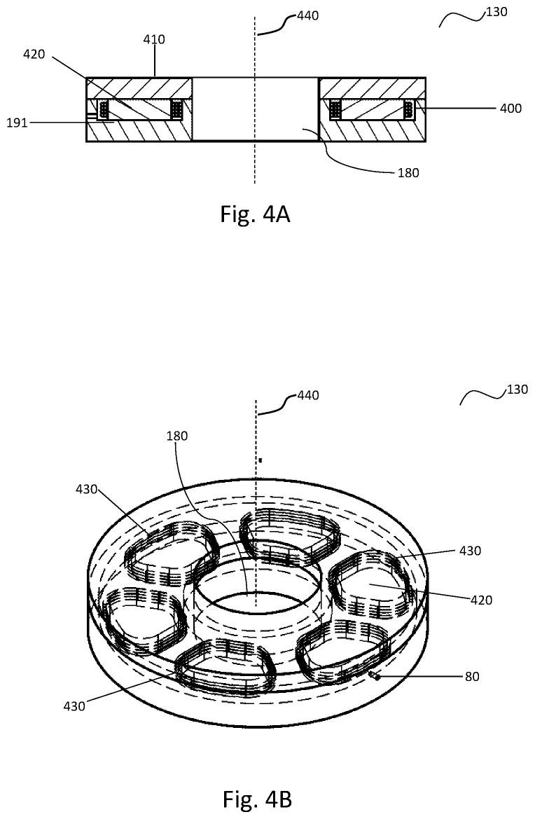

FIGS. 4A and 4B show the stator 130 of one of the preferred embodiments. The stator 130 has a substantially co-axial aperture 180 affixed to the lower portion 123 of the rod 120, and it is disk-shaped and encased in housing 190 and 191. The stator comprises an annular-shaped body 410 that supports one or more pairs of coils 430 that are electrically powered to create electromagnets. Each coil is wound around a stator core 420 and mounted to the stator body 410 disposed in a substantially annular configuration around the longitudinal axis of the stirrer 440. The stator 130 has windings 400 radially extending from the middle of the stator 130 toward the circumference, and the windings 400 align with permanent magnets 500 on the rotor 150. The stator windings 400 are sealed within the housing 190 and 191. The stator core 420 and stator body 410 may be made from the same material and/or manufactured as the same piece. In preferred embodiments, the electrical wires forming the coils are single-drawn copper or copper alloy wires, twisted pairs of wires, or twists of several wires. The stator may be filled with epoxy resin to exclude air.

In other embodiments, the stator has no windings, and the stator module is manufactured as a single integrated piece using printed circuit board manufacturing processes. The stator may comprise an annular array of multi-layer printed circuit board stator segments, each segment having multiple layers of conductive material electrically connected through other conductive layers. The stator module housing may be printed simultaneously with the rod and the stator or added later using previously described techniques and materials.

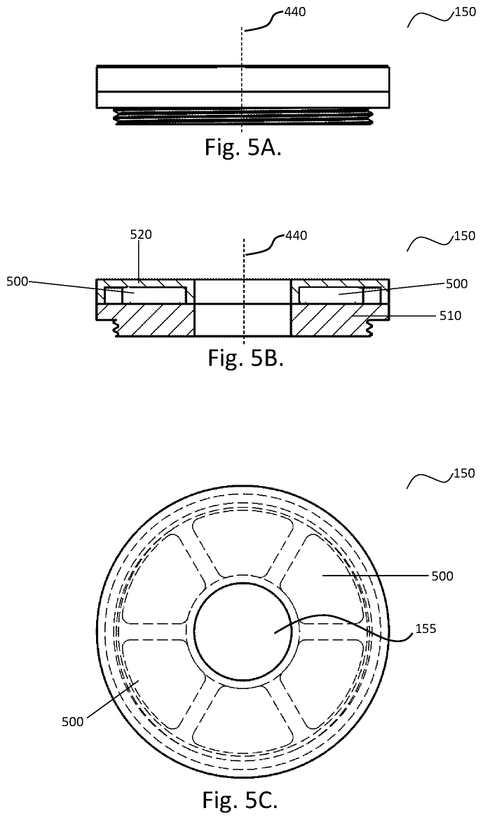

FIGS. 5A-D illustrate the rotor 150 configured to accommodate and rotate the blade assembly 140 about the longitudinal axis 440 of the stirrer 100. The rotor 150 is provided with a plurality of permanent magnets 500 interacting with the coils 400 of the stator 130 to rotate the rotor when the coils are energized. Each magnet has a south pole, a north pole, and an axis that extends between the magnet's south pole and the north pole. The magnets 500 are mounted to a rotor body 510 in a substantially annular configuration around the longitudinal axis of the stirrer 440 and have their axes substantially parallel to each other and perpendicular to the stirrer's axis 440. The array of magnets 500 may be bound to or otherwise connected to the rotor housing 520. The permanent magnets 500 may be high-energy-density magnets, such as neodymium-iron-boron-based or samarium-cobalt-based magnets. In some embodiments, the magnet poles may have a rectangular or trapezoidal shape, or the magnets are bound together to form a continuous circular shape alternating one or more sets of south and north magnetic poles.

The rotor body 510 and housing 520 may be made out of nonmagnetic materials, such materials selected from the following non-inclusive group of metals, alloys, plastics, ceramics, and inorganic materials. The list of suitable metals and alloys may include but is not limited to, copper, aluminum, brass, bronze, stainless steel, Hastelloy, and Inconel. The list of suitable plastics may include but is not limited to fluoropolymers, resins, such as epoxy resin), polyethers (such as polyetherketone, polyetheretherketone, polyetherketoneketon, polyetherketoneetherketoneketone), ethylene chlorotrifluoroethylene, technical ceramics, ethylene propylene diene methylene, ethylene propylene rubber, polychloroprene, polyimide, fluoroelastomers, polypropylene, polyethylene, and copolymers, mixtures, blends and alloys thereof; and such copolymers, mixtures, blends combined with metals or metal alloys.

In certain embodiments, portions of the rotor and other rotor module components can be painted, sprayed, coated, plated, electro-plated, or treated with corrosion-resistant materials. Such materials may be selected from but not limited to the following list: plastics, fluoropolymers, gold, platinum, palladium, chromium, and ceramics.

In certain embodiments, portions of the rotor and the other rotor module components can be coated or treated for corrosive resistance with Inconel, epoxy, polyetheretherketone (PEEK), ethylene chlorotrifluoroethylene copolymer, and/or other treatments.

For operation, the user powers up the controller to input the desired temperature for the medium directly or indirectly via the other controller or computers configured to receive such input. Then, the user submerges the impeller or the impeller together with the rotor in the medium 20. Then, the user turns the controller on to energize the stator to rotate the rotor module. The controller controls the stirring speed and the stirrer's cooling activity. After each use, the user may remove the stirrer from the container and decouple the stator module 110 from the rotor module 140 to clean, disinfect, maintain or repair the blade assembly, stator module, rotor, and coupling between the stator module and the rotor module before further use.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). The term “plurality”, as used herein, is defined as two or more than two. The term “another”, as used herein, is defined as at least a second or more. The term “coupled,” as used herein, is defined as “connected,” although not necessarily directly, and not necessarily mechanically. The term “configured to” describes hardware, software or a combination of hardware and software that is adapted to, set up, arranged, commanded, altered, modified, built, composed, constructed, designed, or that has any combination of these characteristics to carry out a given function.

What is claimed is:

1. An apparatus for stirring a medium, said apparatus having an axis and comprising:
a stator module disposed within a single housing and comprising:
an annular-shaped stator having a substantially co-axially disposed stator aperture, the stator comprising electrical windings,
and
a stationary rod having a first end and a second end and the second end extends through said stator aperture, wherein the stator module housing prevents the medium from contacting the stator and windings when the apparatus is at least partially submerged in the medium;
a rotor disposed within a single rotor housing and rotatably coupled to the second end of the rod through removable coupling means, said rotor comprising:
a plurality of permanent magnets mounted in an annular array on a rotor body, said magnets and said rotor body connected to the housing,
wherein the rotor housing prevents the medium from contacting the rotor when the apparatus is at least partially submerged in the medium and wherein the rotor is located adjacent to and substantially co-axial with the stator and the plurality of magnets of the rotor are arranged with magnet axes substantially perpendicular to that of the axis of the apparatus and facing the electrical windings of the stator to thereby rotate about the windings when driven by the electromagnetic forces provided by the stator and windings; and
an impeller removably coupled to the rotor and configured to be rotated about the axis of the apparatus.

2. The apparatus in claim 1, wherein at least a portion of the rod is made out of thermally conductive material.

3. The apparatus in claim 1, wherein the rod further comprises an enclosed cavity containing a liquid capable of evaporating upon absorbing heat from the stator and traveling in its vapor phase to the first end of the rod to condense and release heat and then traveling to the second end of the rod while in liquid phase, thereby cooling the rod and the stator.

4. The apparatus in claim 2 or 3, further comprising a heat sink coupled to the first end of the rod wherein the heat sink is configured to facilitate the condensing of the liquid inside the rod by transferring the heat away from the second end of the rod through thermal conductivity.

5. The apparatus in claim 4, further comprising
one or more temperature probes capable of sensing the temperature of the stator;
and
a controller configured to receive the temperature information from the temperature probes of the stator and, in response thereto, to vary the rotor rotational speed by powering on and off the current the windings receive to maintain a temperature of the stator.

6. The apparatus in claim 5, further comprising:
one or more temperature probes placed in the medium to sense the temperature of the medium;
wherein the controller is configured to receive a desired temperature value for the medium from a user;
and
wherein the controller is configured to receive temperature information from the one or more probes placed in the medium and the one or more temperature probes of the stator and vary the rotor rotation speed by powering on and off the current the windings receive that energizes the stator windings to maintain a rotor rotation speed to maintain a temperature of the medium or a rate of cooling of the medium.

7. The apparatus in claim 4, further comprising a fan configured to facilitate the condensation of the liquid inside the rod by transferring the heat away from the second end of the rod through thermal conductivity.

8. The apparatus in claim 5, further comprising a fan energized by direct current through the controller, the fan configured to facilitate the condensation of the liquid inside the rod by transferring the heat away from the second end of the rod through thermal conductivity
wherein the controller configured to receive a desired temperature value for the medium as input by a user, temperature information from one or more probes placed in the medium to sense the temperature of the medium, and the temperature sensors of the stator module,
wherein the controller is configured to vary the speed of the fan by varying the current the fan receives and vary the rotor rotational speed by powering on and off the current the windings receive to maintain a temperature of the stator,
and
wherein the controller is configured to energize the stator windings and operate the fan simultaneously to maintain the temperature and/or the rate of cooling of the medium.

9. The apparatus in claim 3, further comprising:
a vapor-compression refrigeration system powered by a direct current source and comprising an evaporator through which a refrigerant flows and a compressor capable of varying the rate of flow of the refrigerant through the evaporator, wherein the stationary rod comprises a cavity connected to the evaporator and configured to receive the refrigerant from the evaporator to cool the stator module through thermal conduction.

10. The apparatus in claim 9, further comprising:
one or more temperature sensors capable of sensing the temperature of the stator module;
and
a controller configured to receive temperature information from one or more probes placed in the medium to sense the temperature of the medium and the temperature sensors of the stator module, said controller is configured to vary the speed of the compressor by varying the current the compressor receives;
wherein a user is capable of inputting a temperature value for the medium in the controller; and wherein the controller is configured to energize the stator windings and operate the vapor-compression refrigeration system simultaneously to maintain the temperature and/or the rate of cooling of the medium.

11. A method for stirring a medium with an apparatus having an axis, comprising the steps of:
connecting an impeller to a rotor disposed within a single rotor housing via a threaded connection, wherein the impeller comprises a plurality of blades equally spaced from each other and attached to a ring-shaped mounting member having threads, and the rotor comprises an annular array of magnets with magnetic poles connected to a rotor body and the rotor housing, such motor housing having threads configured to couple the rotor to the ring-shaped mounting member of the impeller so that the impeller is rotatable about the axis;
removably connecting a stator module encapsulated in a single stator module housing to the rotor through one or more screws or bolts, wherein the stator module comprises
an annular-shaped stator having a substantially co-axially disposed stator aperture, said stator comprising electrical windings,
and
a stationary rod having a first end fixedly mounted and extending through the stator aperture wherein the rotor is located adjacent to and substantially co-axial with the stator and the plurality of rotor magnets are arranged with magnet axes substantially perpendicular to that of the axis of the apparatus and facing the electrical windings of the stator module to thereby rotate about the windings when driven by the electromagnetic forces provided by the stator and windings;
connecting the stator module to a controller configured to energize the stator windings;
partially immerging the apparatus in the medium to be stirred;
and
powering up the controller to power up the windings to create electromagnetic forces to rotate the rotor about the axis of the apparatus.

12. A method for stirring a medium with an apparatus having an axis, comprising the steps of:
connecting an impeller to a rotor disposed within a single rotor housing via a threaded connection, wherein the impeller comprises a plurality of blades equally spaced from each other and attached to a ring-shaped mounting member having threads, and the rotor comprises an annular array of magnets with magnetic poles connected to a rotor body and the rotor housing, such motor housing having threads configured to couple the rotor to the ring-shaped mounting member of the impeller so that the impeller is rotatable about the axis;
removably connecting a stator module encapsulated in a single stator module housing to the rotor through one or more screws or bolts, wherein the stator module comprises
an annular-shaped stator having a substantially co-axially disposed stator aperture, said stator comprising electrical windings,
and
a stationary rod made out of a thermally conductive material, said rod having a first end fixedly mounted and extending through the stator aperture and a second end having threads capable of receiving a heat sink via its heat sink threads wherein the rotor is located adjacent to and substantially co-axial with the stator and the plurality of rotor magnets are arranged with magnet axes substantially perpendicular to that of the axis of the apparatus and facing the electrical windings of the stator module to thereby rotate about the windings when driven by the electromagnetic forces provided by the stator and windings;
connecting a heat sink to the second end of the rod via the heat sink threads;
connecting the stator module to a controller configured to energize the stator windings;
partially immerging the apparatus in the medium to be stirred;
and
powering up the controller to power up the windings to create electromagnetic forces to rotate the rotor about the axis of the apparatus.

13. A method for stirring a medium with an apparatus having an axis, comprising the steps of:
connecting an impeller to a rotor disposed within a single rotor housing via a bayonet lock, wherein the impeller comprises a plurality of blades equally spaced from each other and attached to a mounting member having a plurality of slots, and the rotor comprises an annular array of magnets with magnetic poles connected to a rotor body and the rotor housing, such rotor housing having threads configured to couple the rotor to the ring-shaped mounting member of the impeller so that the impeller is rotatable about the axis;
removably connecting a stator module encapsulated in a single stator module housing to the rotor through screws or bolts, wherein the stator module comprises
an annular-shaped stator having a substantially co-axially disposed stator aperture, said stator comprising electrical windings,
and
a stationary rod having a first end fixedly mounted and extending through the stator aperture wherein the rotor is located adjacent to and substantially co-axial with the stator, and the plurality of rotor magnets are arranged with magnet axes substantially perpendicular to that of the axis of the apparatus and facing the electrical windings of the stator module to thereby rotate about the windings when driven by the electromagnetic forces provided by the stator and windings;
connecting the stator module to a specified controller configured to energize the stator windings;
partially immersing the apparatus in the medium to be stirred;
and
powering up the specified controller to power up the windings to create electromagnetic forces to rotate the rotor about the axis of the apparatus.

14. A method for stirring a medium with an apparatus having an axis, comprising the steps of:
connecting an impeller to a rotor disposed within a single rotor housing via a bayonet lock, wherein the impeller comprises a plurality of blades equally spaced from each other and attached to a mounting member having a plurality of slots, and the rotor comprises an annular array of magnets with magnetic poles connected to a rotor body and the rotor housing, such rotor housing having threads configured to couple the rotor to the ring-shaped mounting member of the impeller so that the impeller is rotatable about the axis;
removably connecting a stator module encapsulated in a single stator module housing to the rotor through one or more screws or bolts, wherein the stator module comprises
an annular-shaped stator having a substantially co-axially disposed stator aperture, said stator comprising electrical windings,
and
a stationary rod made out of a thermally conductive material, said rod having a first end fixedly mounted and extending through the stator aperture and a second end having threads capable of receiving a heat sink via its heat sink threads wherein the rotor is located adjacent to and substantially co-axial with the stator and the plurality of rotor magnets are arranged with magnet axes substantially perpendicular to that of the axis of the apparatus and facing the electrical windings of the stator module to thereby rotate about the windings when driven by the electromagnetic forces provided by the stator and windings;
connecting a heat sink to the second end of the rod via the heat sink threads;
connecting the stator module to a controller configured to energize the stator windings;
partially immerging the apparatus in the medium to be stirred;
and
powering up the controller to power up the windings to create electromagnetic forces to rotate the rotor about the axis of the apparatus.

15. An apparatus for stirring a medium said apparatus having an axis and comprising:
an impeller connected via a threaded connection to a rotor disposed within a single rotor housing, wherein the impeller comprises a plurality of blades equally spaced from each other and attached to a ring-shaped mounting member having threads, and the rotor comprises an annular array of magnets with magnetic poles connected to a rotor body and the rotor housing, such motor housing having threads configured to couple the rotor to the ring-shaped mounting member of the impeller so that the impeller is rotatable about the axis of the apparatus;
a stator module encapsulated in a single stator module housing wherein the stator module comprises
an annular-shaped stator having a substantially co-axially disposed stator aperture, said stator comprising electrical windings,
and
a stationary rod made out of a thermally conductive material, said rod have a first end fixedly mounted and extending through the stator aperture and a second end having threads capable of receiving a heat sink via its heat sink threads wherein the rotor is removably connected to the first end of the stator module through one or more screws or bolts and the rotor is located adjacent to and substantially co-axial with the stator and the plurality of rotor magnets are arranged with magnet axes substantially perpendicular to that of the axis of the apparatus and facing the electrical windings of the stator module to thereby rotate about the windings when driven by the electromagnetic forces provided by the stator and windings;
a heat sink connected to the second end of the rod via the heat sink threads;
and
a controller configured to energize the stator windings and to create electromagnetic forces to rotate the rotor about the axis of the apparatus.

16. An apparatus for stirring a medium said apparatus having an axis and comprising:
a rotor encapsulated in a single rotor housing, the rotor comprising an annular array of magnets with magnetic poles connected to a rotor body and the rotor housing;
an impeller having a plurality of blades equally spaced from each other and attached to a mounting member having a plurality of slots;
a locking mechanism configured to removably secure the impeller to the rotor, said locking mechanism comprising a plurality of arms extending radially from the rotor and through the corresponding slots on the impeller's mounting member, wherein the arms engage with the slots in a rotational motion around the central axis for facilitating a secure connection between the impeller and the rotor so that the impeller is rotatable about the axis of the apparatus;
a stator module encapsulated in a single stator module housing wherein the stator module comprises
an annular-shaped stator having a substantially co-axially disposed stator aperture, said stator comprising electrical windings,
and
a stationary rod made out of a thermally conductive material, said rod has a first end fixedly mounted and extending through the stator aperture and a second end having threads capable of receiving a heat sink via its heat sink threads wherein the rotor is removably connected to the first end of the stator module through one or more screws or bolts and the rotor is located adjacent to and substantially co-axial with the stator and the plurality of rotor magnets are arranged with magnet axes substantially perpendicular to that of the axis of the apparatus and facing the electrical windings of the stator module to thereby rotate about the windings when driven by the electromagnetic forces provided by the stator and windings;
a heat sink connected to the second end of the rod via the heat sink threads;
and
a controller configured to energize the stator windings and to create electromagnetic forces to rotate the rotor about the axis of the apparatus.

17. The apparatus according to claim 1, 2, 3, 15, or 16 in which the stator module housing is selected from the group consisting of xylan, polytetrafluoroethylene, fluoroethylenepropylene, polyphenylenesulfide, polyvinylidenedifluoride, tetrafluoroetheylene, perfluoroalkoxyalkane, ethylenetetrafluoroethylene, and ethylenechlorotrifluoroethylene.

18. The apparatus according to claim 1, 2, 3, 15, or 16 wherein the rotor module housing is selected from the group consisting of xylan, polytetrafluoroethylene, fluoroethylenepropylene, polyphenylenesulfide, polyvinylidenedifluoride, tetrafluoroetheylene, perfluoroalkoxyalkane, ethylenetetrafluoroethylene, and ethylenechlorotrifluoroethylene.
